(19) United States
(12) Patent Application Publication
(10) Pub. No.: US 2009/0317574 A1
(43) Pub. Date: Dec. 24, 2009

(54) FLANGE FOR A BLOW-MOLDING CONTAINER

(75) Inventor: Marcelo Firpo Musumeci, Sao Bernardo do Campo-SP (BR)

Correspondence Address: OBLON, SPIVAK, MCCLELLAND MAIER & NEUSTADT, L.L.P., 1940 DUKE STREET, ALEXANDRIA, VA, 22314, US

(73) Assignee: FUNCI. DRINKS INTEL. EM DESEN. DE PRODUTOS LTDA., Valinhos - SP (BR)

(21) Appl. No.: 12/441,250

(22) PCT Filed: Sep. 13, 2006
(86) PCT No.: PCT/BR06/00185

§ 371 Date: Mar. 13, 2009

(51) Int. Cl. B32B 1/00; B32B 3/02

(52) U.S. Cl. 428/35.7; 428/80

(57) ABSTRACT

A flange of a plastic container particularly adequate to receive a metallic lid that is seamed onto the flange. The flange includes an external diameter, an internal diameter, a necking rim, a rim thickness, an external radius, an internal radius, and a fluidness triangle that includes a vertex. The difference between the size of the external diameter and the size of the internal diameter is between about 2.50 mm and about 4.30 mm; and the rim thickness is between about 18% and about 36% of the internal height of the metallic lid that is intended to be seamed in the flange.

### FIELD OF INVENTION

The present invention refers to, in general terms, a container of polymeric material associated with a metallic lid.

More specifically, the present invention refers to a container of polymeric material with a flange of suitable geometric proportions to receive a metallic lid, fixed by mechanical sealing.

### BACKGROUND OF THE INVENTION

There are some attempts to fix, by seaming, a metallic lid to the opening of a polymeric container, usually obtained by the blowing process. This is due to the replacement of the metallic container, aluminum or steel, by a container of polymeric material that reduces the production costs, due to being a polymeric material, usually polyethylene tereftalate (PET), an easier product to conform and of a cheaper raw material, when compared to steel or aluminum.

Furthermore, the replacement by a polymeric material allows the consumer to visualize the product contained within the container. This is advantageous because the consumers appreciate, at the moment of purchase and/or consumption, checking if the product looks all right, if there is a suitable quantity of the product, or if it is in adequate conditions for consumption.

The state of the art discloses some of these attempts for substitution of the metallic containers for containers in polymeric material in packaging that employ seamed metallic lids.

The documents EP 1 080 870, U.S. Pat. No. 4,667,384, U.S. Pat. No. 4,365,724, U.S. Pat. No. 4,184,444 and U.S. Pat. No. 3,685,685 show methods and containers that consist of a polymeric material body associated with a metallic lid fixed by seaming.

However, all of these solutions found in the state of the art, have the enduring problem of the seal between the metallic lid and the plastic container. Due to being materials of distinct mechanical properties, the seaming of the metallic lid to the plastic container is not perfect, allowing for the passage of atmospheric air into the interior of such container. The oxygen in the atmospheric air oxidizes the packaged product, decreasing the product life or even makes this type of packaging impossible to be employed. Furthermore, if liquid products or products that must be under an inert atmosphere or under pressure are packaged, there may be leakage of both the liquid product and the gas employed.

Therefore, an objective of the present invention is to provide a container of polymeric material associated with metallic lid fixed by seaming where the seal prevents substantially the entrance of atmospheric air into such container.

Another objective of the present invention constitutes a container of polymeric material associated with a metallic lid fixed by seaming that prevents the leakage into the atmosphere of the product or the gas contained within the container.

### DESCRIPTION OF THE INVENTION

The objectives stated above, among others, are achieved with the present invention that constitutes a container of polymeric material where its flange consists of:
an external diameter of seaming (DER);
an internal diameter of seaming (DIR);
a seaming border (BR);
a thickness of the seaming border (EBR);
an external seaming radius (R1);
an internal seaming radius (R2); e
a fluidity triangle (TF) that consists of a vertex (VTF);
   wherein the difference between the DER measurement and the DIR measurement is comprehended between about 2.00 mm and about 4.40 mm, particularly between about 2.50 mm and about 4.30 mm; and the EBR is comprised between about 18% and about 36%, particularly between about 20% and about 30%, more particularly between about 22% and about 26%, even more particularly about 24% of the internal height (Al) of the metallic lid to which it is seamed.

It has been verified that for non-carbonated liquid products, a particularly—suitable measurement for the difference between the DER measurement and the DIR measurement is about 3.00 mm.

It was also verified that for carbonated liquid products, a measurement particularly suitable for the difference between the DER measurement and the DIR measurement is of about 4.00 mm.

It was also observed that the EBR measurement at about 24% in relation to the internal height of the metallic lid is particularly suitable both for carbonated liquid products and for non-carbonated liquid product.

Alternatively, the flange consists also of a base for blowing (BS), over which extends the blowing pre-form and conforming of the container body. The dimensions of the blowing base may vary according to the pre-form, and does not constitute a relevant aspect to the present invention. The pre-form must be suitable for conforming the container body, especially by the blowing process.

The external seaming diameter (DER) corresponds to the most external diameter of the container flange, and the internal seaming diameter (DIR) corresponds to the internal diameter of the container, within which the metallic lid is fitted.

The thickness of the seaming border (EBR) is the measurement formed by the thickness of the seaming border material (BR), which will be seamed with the metallic lid.

The seaming border (BR) is the border resulting from the difference between the DER and the DIR, and that is folded along with the border of the metallic lid to form the seaming. Its thickness, the EBR, is resulting from the internal height (Al) of the metallic lid.

The external (R1) and internal (R2) seaming radius are those formed between the seaming border (BR) and the vertex of the fluidity triangle (VTF), in relation to the external and internal portions of the seaming border, respectively, forming between the VTF and the BR an angle of about 90 degrees. The external (R1) and internal (R2) radii offer a relief in the tension accumulation at the border, hence increasing, the mechanic resistance, aiding in the formation of the border (BR) during the material injection process and making the material drainage in the seaming process easier. The external (R1) and internal (R2) radii have measurements between about 0.50 mm and about 2.00 mm, especially between about 1.00 mm and about 1.5 mm.

The fluidity triangle is the triangle formed between the seaming border and the base for blowing. This triangle serves as structure to support the base for blowing, over which the pre-form body extends itself, as explained above. The fluidity triangle also helps in the fluidity of the polymeric material during the pre-form injection process, for the formation of the seaming border (BR) as well as offering a suitable material drainage at the moment of seaming, avoiding rupture due to lack of material. Especially, the fluidity triangle vertex (VTF) has an angle comprised between about 9° and about 15°, more particularly between 11° and 13°, even more particularly of about 12°, and the thickness of its vertex must not be lower that the thickness of the seaming border (EBR). The fluidity triangle must have a greater angle close to its base, but must comprehend a measurement between about 2 mm and about 3 mm near its vertex.

The polymeric material used in the container may be any suitable polymeric material, and is, in preference, the same as that used in its flange. Particularly suitable are the polymers capable of being injected by blow-molding, for instance, the polymers chosen within the polyolefins (for example, polypropylene or polyethylene), polyacryilonitril, polyfenylene sulphite, polycarbonate, polyesters (for instance, polybutylene tereftalate or polyethylene tereftalate), these copolymers among themselves or with others. Particularly suitable is the polyethylene tereftalate (PET).

The container may be obtained by a process of conventional blowing, as well as the seaming of the metallic lid due to being carried out by a conventional process.

The metallic lid employed may be any metallic lid found on the market that is suitable for seaming, including those made of aluminum or stainless steel.

### BRIEF DESCRIPTION OF THE DRAWINGS

The improvements and effects of the present invention will be apparent to those skilled in the art from the detailed description presented as follows, making reference to the attached images, given only for illustrative purpose. The images are schematics and their dimensions and proportions may not correspond to the reality, since their goal is only to illustrate the present invention in a didactic manner, without imposing any limitations except those contained in the claims hereinafter presented, such that:

FIG. 1 is a cut view of a pre-form of the plastic container, illustrating the flange over which the metallic lid is seamed;

FIG. 2 is a partial cut view, illustrating the container associated with the seamed metallic lid;

FIG. 3 is a detailed view of the seamed lid to the flange; and

FIG. 4 is a side cut view of a metallic lid, before being seamed, illustrating the internal height (Al).

### DESCRIPTION OF A PARTICULAR REALIZATION

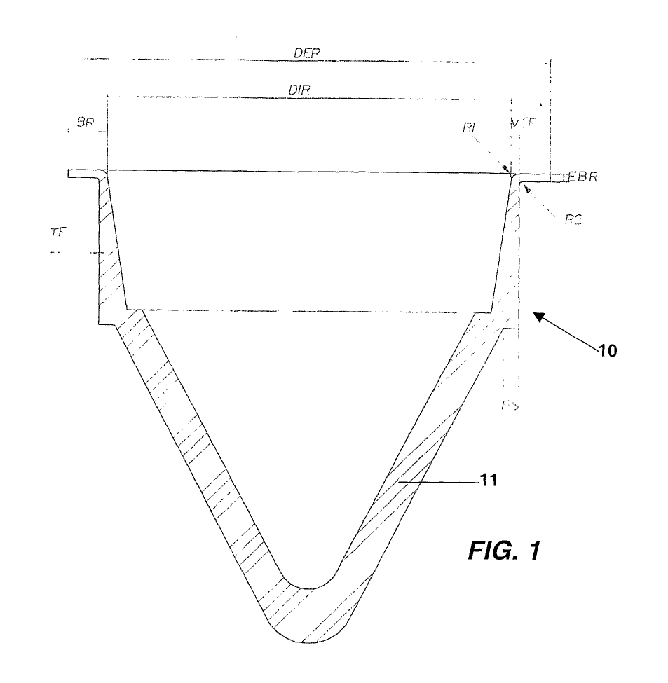

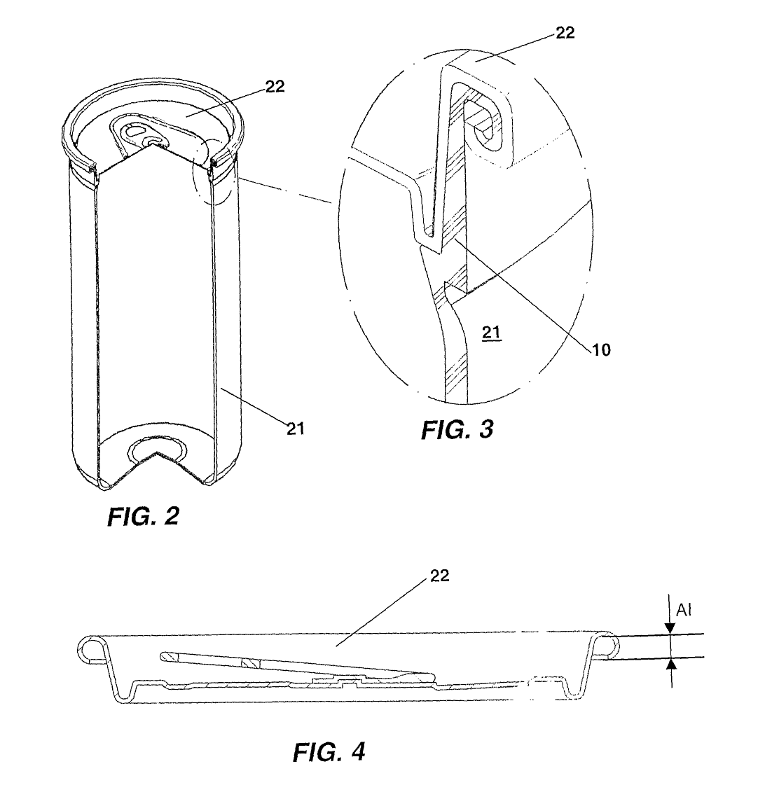

In relation, firstly, to FIG. 1, it is illustrated the flange (10) and the pre-form (11) that is blown to form the plastic container. The flange (10) has geometric proportions that allow for an excellent seal between such container and a metallic lid fixed by seaming, as illustrated in FIGS. 2 and 3.

The recipient flange consists of an external seaming diameter (DER), an internal seaming diameter (DIR), a seaming border (BR), a seaming border thickness (EBR), an external seaming radius (R1), an internal seaming radius (R2), a fluidity triangle (TF) that comprehends a vertex (VTF), and a blowing base (BS).

The measurement of the seaming border must be constant and is obtained from the difference between the DER measurement and the DIR measurement. This difference must be comprised between about 2.00 mm and about 4.40 mm, particularly between about 2.50 mm and 4.30 mm. For instance, if the DIR measurement is of 50 mm, the DER measurement may be of approximately 54.30 mm. The seaming border will have, thus, an approximate measurement of 2.15 mm.

Analogously, the thickness of the seaming border (EBR) is resulting from the internal height measurement (Al) of the metallic lid. This thickness is comprised between about 18% and about 36%, particularly between about 20% and about 30%, more particularly between about 22% and about 26%, even more particularly about 24% in relation to the measurement of the internal height (Al) of the metallic lid. Or rather, if the internal height of the metallic lid is of 1.73 mm, as illustrated in FIG. 4, the EBR is approximately 0.4 mm.

It was found that with these geometric proportions one achieves an excellent seal between the polymeric material container and a metallic lid fixed by seaming.

Furthermore, other particular geometric proportions contribute to the seal between the metallic lid and the plastic container.

The external (R1) and internal (R2) seaming radius comprises approximately 0.5 mm, and the fluidity triangle comprehends a vertex (VTF) with a thickness equal to the thickness of the seaming border (EBR). The angle of its vertex is of approximately 12°. Below about 2 mm from the vertex, the angle may vary, to more or to less, which has no influence on the seal between the metallic lid and the container flange.

The flange consists also of a blow base (BS), over which extends the pre-form body (11) that is blown to form the plastic container.

FIG. 2 illustrates a partial cut view of the plastic container associated with a metallic lid according to the present invention. The container pre-form (11) was blown employing conventional processes, obtaining the desired cylindrical form, as illustrated. A particular content, such as a beverage, is filled out in the container. A metallic lid (22) is, then, seamed by conventional means, particularly by the process known as double seaming, to the container flange (10), and the products is ready for sale.

According to the present invention, the inconveniences found in the state of art in relation to the plastic containers associated with seamed metallic lids are overcome, since it prevents that the atmospheric oxygen penetrates the interior of the container, preventing the oxidation of the package content, as well as preventing the leakage of the product contained in the container, or the gas employed in making the container atmosphere inert or the product carbonation, if employed.

It must be recognized that, although the present invention has been described in relation to a particular realization, those skilled in the art may develop variations to structural and operational details, as well as being able to expand the object described above to other types of application without, however, deviating from the principles of the present invention. Therefore, the attached claims must be interpreted as comprehending all equivalents that fit within the scope of the invention.

1-14. (canceled)

15. A flange for a polymeric container, comprising:
an external seaming diameter;
an internal seaming diameter;
a seaming border;
a seaming border thickness;
an external seaming radius;
an internal seaming radius;
a blowing base; and
a fluidity triangle that includes a vertex,
wherein the difference between the external seaming diameter and the internal seaming diameter is between about 2.50 mm and about 4.30 mm; and
the seaming border thickness is between about 18% and about 36% of the internal height measurement of the metallic lid that is seamed.

16. A flange, according to claim 15, wherein the difference between the external seaming diameter measurement and the internal seaming diameter measurement is approximately 3 mm when the polymeric container is filled with non-carbonated liquid products.

17. A flange, according to claim 15, wherein the difference between the external seaming diameter measurement and the internal seaming diameter measurement is approximately 4 mm when the polymeric container is filled with carbonated liquid products.

18. A flange, according to claim 15, wherein the seaming border thickness is between about 20% and about 30% of the internal height measurement of the metallic lid that is seamed.

19. A flange, according to claim 15, wherein the seaming border thickness is between about 22% and about 26% of the internal height measurement for the metallic lid that is seamed.

20. A flange, according to claim 15, wherein the seaming border thickness is approximately 24% of the internal height measurement of the metallic lid that is seamed.

21. A flange, according to claim 15, wherein the external radius and the internal radius of seaming is between about 0.5 mm and 2.00 mm, or between about 1.00 mm and about 1.5 mm.

22. A flange, according to claim 15, wherein the vertex angle of the fluidity triangle is between about 9° and 15°, or between about 11° and 13°, or about 12°.

23. A flange, according to claim 15, wherein the thickness of the vertex of the fluidity triangle is approximately equal to the thickness of the seaming border.

24. A flange, according to claim 15, wherein a polymeric material used is chosen within the polyolefins, or polypropylene or polyethylene, polyacrylonytril, polyfenilene sulphite, polycarbonate, the polyesters, in particular polybutylene tereftalate or polyethylene tereftalate, copolymer of these between themselves or with others.

25. A flange, according to claim 15, wherein the polymeric material is the polyethylene tereftalate (PET).

26. A plastic container, comprising a flange as defined in claim 15.

27. A plastic container, comprising a flange according to claim 15 and a lid of metallic material seamed to the flange.

28. A pre-form of a plastic container, comprising a flange as defined in claim 15.
